(19) United States
(12) Patent Application Publication
(10) Pub. No.: US 2012/0217362 A1
(43) Pub. Date: Aug. 30, 2012

(54) DRAPERY ROD BRACKET AND COVER PLATE

(75) Inventor: Mauricio AFFONSO, Toronto (CA)

(73) Assignee: UMBRA LLC, Buffalo, NY (US)

(21) Appl. No.: 13/036,693

(22) Filed: Feb. 28, 2011

(51) Int. Cl. A47H 1/102; F16M 13/02

(52) U.S. Cl. 248/222.14; 248/205.1

(57) ABSTRACT

A bracket assembly, including a mounting bracket and a cover plate. The mounting bracket has a wall portion and an extension portion. The wall portion includes a first end and is operatively arranged to be mounted to a substantially planar surface. The extension portion is integral with and extends outwardly from the wall portion and includes a second end. The extension portion is operatively arranged to hold a drapery rod. The cover plate has a first end and a second end. The cover plate is arranged to be attached to the wall portion of the mounting bracket.

### FIELD OF THE INVENTION

The invention broadly relates to window drapery hardware, and, more particularly, to drapery rod brackets.

### BACKGROUND OF THE INVENTION

Drapery rod brackets are functional in that they support a rod and enable a set of curtains or draperies to be hung on the rod over a window. Conventional drapery hardware includes a pair of brackets that are attached to a window frame or wall by means of nails or screws and a rod suspended from the pair of brackets. While drapery rod brackets are functional, such mounting hardware used to support the rod is generally not aesthetically pleasing.

Another problem with prior drapery rod brackets is that the screws or nails that secure the brackets to the window frame or wall can protrude, and thus, snag the curtains or draperies. Many drapery fabrics, such as voile, batiste, chiffon, silk, etc., are extremely delicate. Those delicate fabrics can easily catch on a protruding screw or nail with even the slightest rough edge and permanently damage the draperies.

Thus, there is a long-felt need for a drapery rod bracket that is aesthetically pleasing, such that the design can easily be changed. There is also a long-felt need for a drapery rod bracket where unsightly screws and nails are hidden from view. There is a further long-felt need for a drapery rod bracket that protects the curtains and draperies from catching on the screws or nails that secure the bracket to the window frame or wall.

### BRIEF SUMMARY OF THE INVENTION

The present invention broadly comprises a bracket assembly, including a mounting bracket and a cover plate. In a preferred embodiment, the mounting bracket has a wall portion and an extension portion. The wall portion includes a first end and is operatively arranged to be mounted to a substantially planar surface, such as a wall or window. In the preferred embodiment, the bracket is made of metal and the wall portion is fastened to the wall via at least two screws. The extension portion includes a second end and is integral with and extends outwardly from the wall portion such that the extension portion and the wall portion are substantially perpendicular. The extension portion has a substantially horizontal portion and a curved portion. The curved portion is operatively arranged to hold a drapery rod. The drapery rod is secured within the diameter of the curved portion via a threaded screw, which tightens or loosens to accommodate drapery rods of varying diameters.

In the preferred embodiment, the cover plate has a first end, a second end, a recessed surface, and a raised surface. The cover plate is operatively arranged to matingly engage the wall portion of the mounting bracket. The first end has a slot and the second end has a tab extension extending upwardly from the first end. The extension portion includes an upper surface and a lower surface and the lower surface has a convex projection extending downwardly. The tab extension of the first end is operatively arranged to be secured between the convex projection and the wall portion of the bracket. This causes the cover plate to “latch” behind the convex projection when secured in place. Additionally, the first end of the wall portion includes a protrusion integral with and extending substantially perpendicular to the wall portion. The protrusion is operatively arranged to extend through the slot of the cover plate when the cover plate is secured to the wall portion. In the preferred embodiment, the cover plate is made of plastic.

It is a general object of the present invention to provide a bracket assembly where the cover plate is attached to the wall portion of the bracket and configured in a manner that positions virtually all of the wall portion behind the surface of the cover plate, and thus, completely hiding the wall portion from view. This provides a more aesthetically pleasing bracket assembly. Additionally, the cover plate also prevents the draperies from snagging on the screws or nails that fasten the bracket to the wall.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a front perspective view of the present invention drapery rod bracket and cover plate, illustrating the bracket mounted on a wall and supporting a rod with drapes hanging therefrom;

FIG. 2 is a side perspective view of the present invention shown in FIG. 1;

FIG. 3 is an exploded view of the present invention shown in FIG. 2;

FIG. 3A is an enlarged view of the area 3A shown in FIG. 3, illustrating a convex projection integral with a lower surface of an extension portion of the bracket;

FIG. 4 is a side view of the present invention shown in FIG. 2;

FIG. 5 is a front view of the present invention shown in FIG. 2;

FIG. 6 is a rear view of the present invention shown in FIG. 2;

FIG. 7 is a top plan view of the present invention shown in FIG. 2;

FIG. 8 is a bottom plan view of the present invention shown in FIG. 2;

FIG. 9 is a cross-sectional view of the present invention taken along line 9-9 in FIG. 7, depicting the cover plate secured to the bracket;

FIG. 9A is a cross-sectional view of the present invention, illustrating the cover plate partially detached from the bracket;

FIG. 10A is an enlarged view of the area 10A shown in FIG. 2; and,

FIG. 11A is a partial cross-sectional view of the area 11A shown in FIG. 9.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred embodiments, it is to be understood that the invention as claimed is not limited to the disclosed embodiments.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “curtain” is synonymous with terms such as “drape”, “drapery”, “swathe”, “clothe”, “panel”, “valance”, etc., and such terms may be used interchangeably as appearing in the specification and claims. Although any methods, devices or materials similar or equivalent to those described herein can be used in the practice or testing of the invention, the preferred methods, devices, and materials are now described.

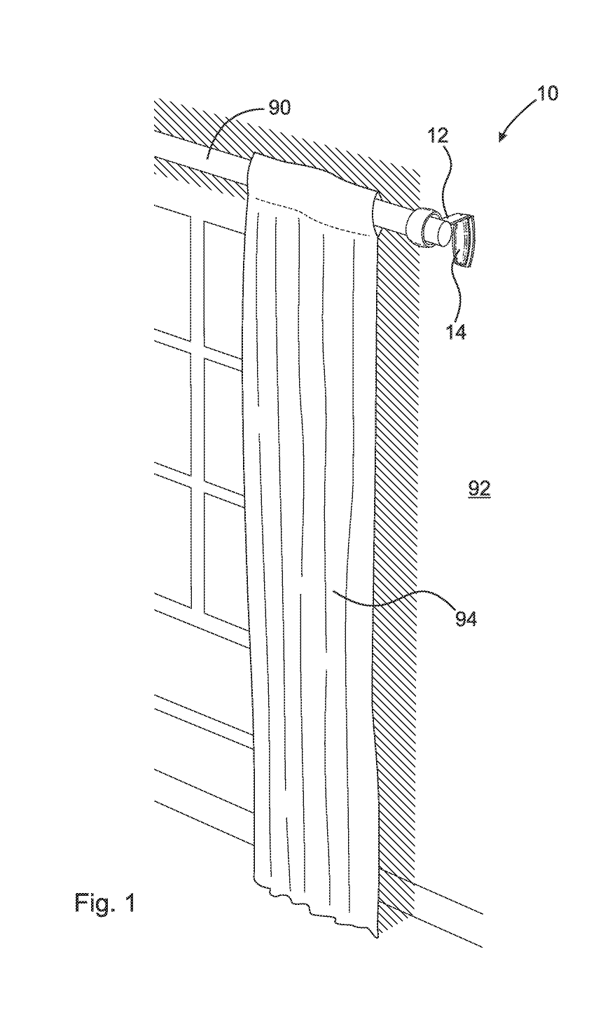

Adverting now to the figures, FIG. 1 illustrates the preferred embodiment of the present invention. FIG. 1 is a front perspective view of drapery rod bracket and cover plate assembly 10 having bracket 12 and cover plate 14. Wall portion 16 (not shown in FIG. 1) of bracket 12 is mounted onto wall 92 and hidden from view behind cover plate 14. Drapes 94 are shown hanging from drapery rod 90, which is supported by bracket 12.

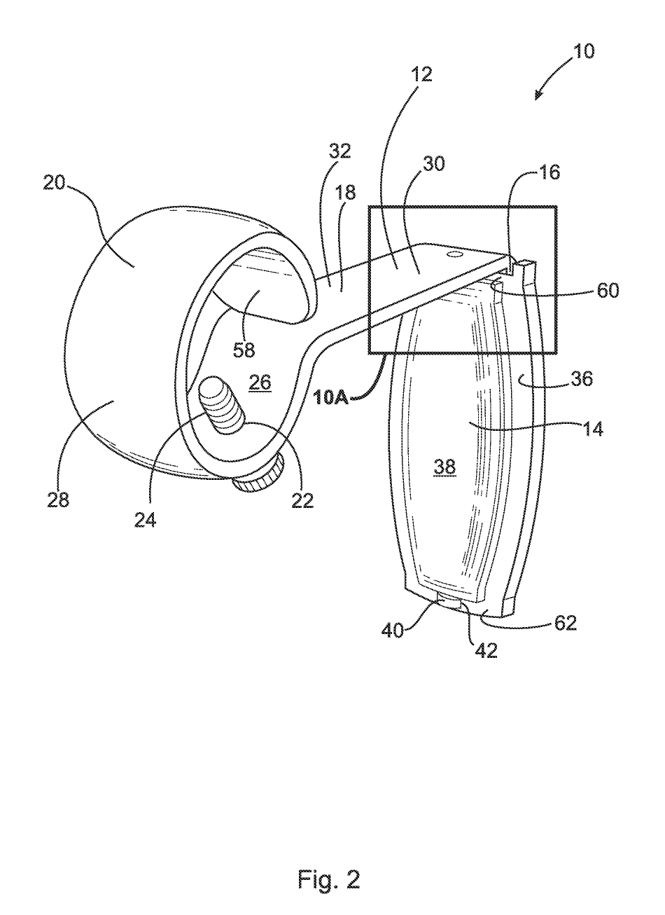

FIG. 2 is a perspective view of bracket assembly 10 shown in FIG. 1. Bracket assembly 10 generally comprises bracket 12 and cover plate 14. Bracket 12 includes wall portion 16 and extension portion 18. Extension portion 18 is joined to or, preferably, integral with, and extends outwardly from wall portion 16, such that wall portion 16 and extension portion 18 are substantially perpendicular to each other. Wall portion 16 is adapted to matingly engage a planar surface, such as wall 92 (not shown in FIG. 2). Extension portion 18 includes horizontal portion 30, curved portion 20, and second end 58. Extension portion 18 includes upper surface 32 and lower surface 34. Lower surface 34 has convex projection 44 extending downwardly, which secures cover plate 14 to wall portion 16. Horizontal portion 30 of extension portion 18 has upper surface 32 and lower surface 34 (not shown in FIG. 2). By integral is meant that the component parts are formed together as a single unit. Curved portion 20 includes inner surface 26, outer surface 28, aperture 22, and screw 24. Curved portion 20 is integral with and extends outwardly from horizontal portion 30. In the preferred embodiment, curved portion 20 is circular in shape and is adapted to hold a drapery rod. Drapery rod 90 (not shown in FIG. 2) is inserted within the diameter of curved portion 20.

Cover plate 14 has first end 62, second end 60, recessed surface 36, and raised surface 38. Cover plate 14 is operatively arranged to be removably secured to wall portion 16 of bracket 12. First end 62 has slot 42 and second end 60 has tab extension 46 extending upwardly from first end 62. Tab extension 46 of first end 62 is adapted to be secured between convex projection 44 and wall portion 16 of bracket 12. This configuration allows cover plate 14 to “latch” behind convex projection 44 in order to secure it in place. First end 62 of wall portion 16 includes protrusion 40 integral with and extending substantially perpendicular to wall portion 16. Protrusion 40 is adapted to extend through slot 42 of cover plate 14 when cover plate 14 is secured to wall portion 16.

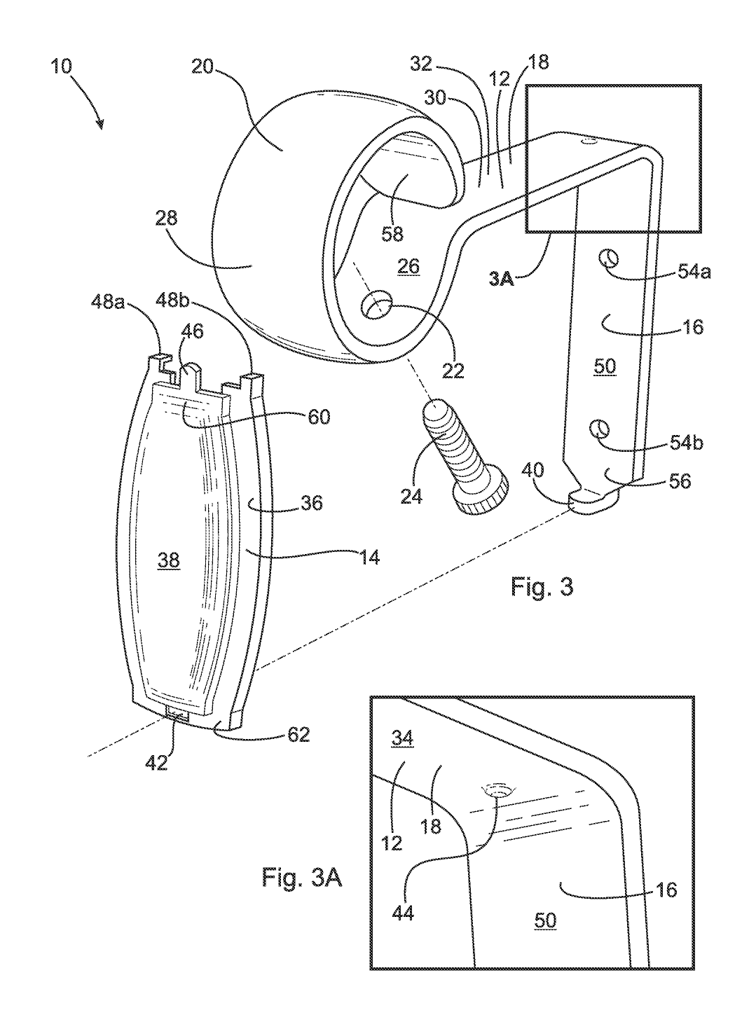

FIG. 3 is an exploded view of bracket assembly 10 shown in FIGS. 1 and 2. Wall portion 16 includes first end 56, front surface 50, rear surface 52 (not shown in FIG. 3), openings 54a, 54b, and protrusion 40. Rear surface 52 of wall portion 16 is fixedly secured to a substantially planar surface, such as wall 92 (not shown in FIG. 3), via screws or nails, which pass through openings 54a, 54b on front surface 50 of wall portion 16.

FIG. 3A is an enlarged view of the area 3A shown in FIG. 3, illustrating a convex projection 44 integral with lower surface 34 of extension portion 18 of the bracket 10.

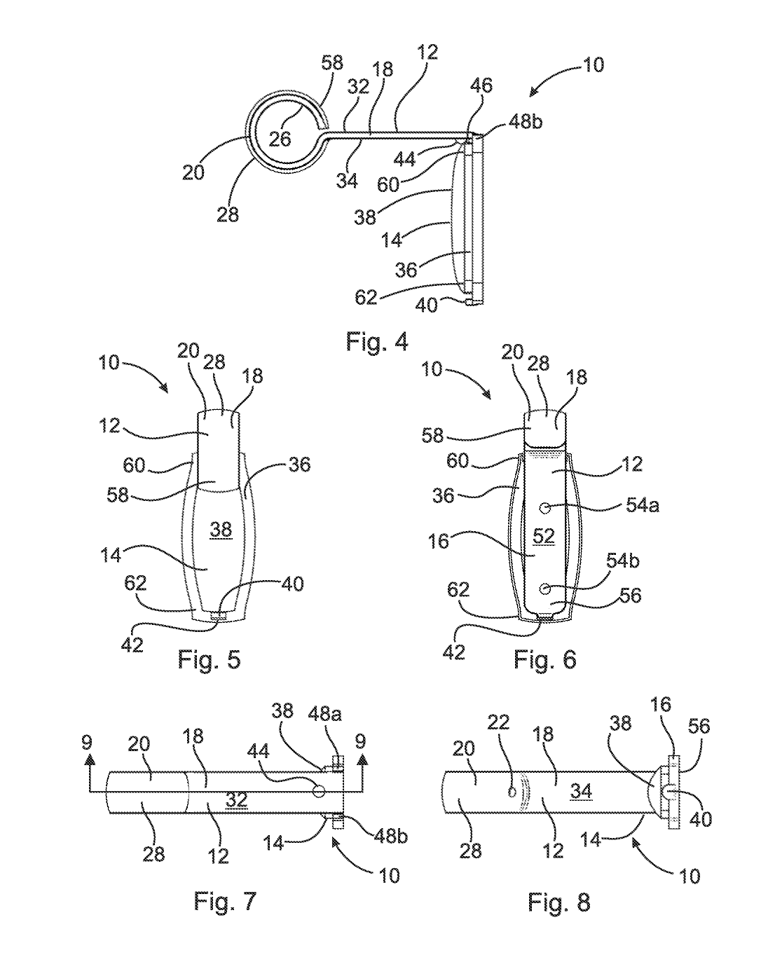

FIG. 4 is a side view of bracket 12 depicting cover plate 14 matingly engaged with wall portion 16. Protrusion 40 extends substantially perpendicularly from first end 62 of wall portion 16. Convex projection 44 is seen projecting from lower surface 34 of extension portion 18. FIG. 4 also shows the embodiment in which cover plate 14 includes raised surface 34 and recessed surface 36 on the outer or visible surface of cover plate 14. FIG. 4 also shows an alternate embodiment in which screw 24 is not used to hold a curtain rod in place.

FIG. 5 is a front view bracket 12 showing protrusion 40 extending through slot 42 of cover plate 14. Also seen more clearly is the contour of the visible surface of cover plate 14 showing raised surface 38 and recessed surface 36 on at least a portion of the perimeter of cover plate 14. FIG. 6 is a rear view of bracket 12 showing fastener holes 54a and 54b through which fasteners such as screws or nails extend to hold bracket 12 in place on wall 92.

FIG. 7 is a top view of bracket 12 showing shoulders 48a and 48b of cover plate 14 extending on either side of top portion 18. FIG. 8 is a bottom view of the present invention. In this view, convex projection 44 is obscured by raised surface 38 demonstrating the preferred embodiment in which convex projection 44 is close to the junction of wall portion 16 and extension portion 18.

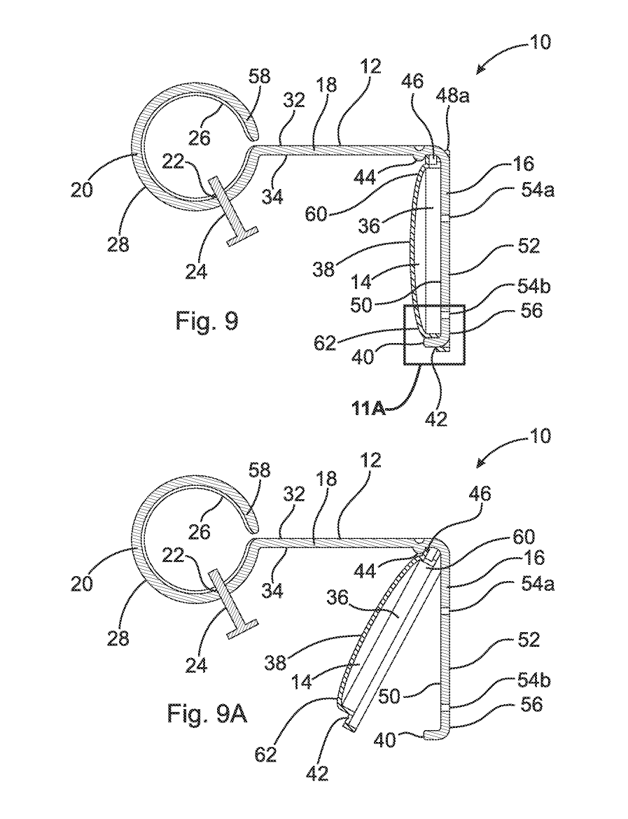

FIG. 9 is a cross-sectional view of bracket 12 taken along line 9-9 in FIG. 7 with cover plate 14 secured to the bracket. Convex projection 44 is shown close to tab extension 46 thereby holding it in place against wall portion 16. Cover plate 14 is shown positioned against front surface 50 of wall portion 16. A space is created between raised surface 38 and wall portion 16 which provides a covered space for projecting fasteners and prevents any damage that could be caused by any projecting fastener heads as well as keeping them from view to provide a more pleasing, aesthetic appearance. Persons of skill in the art will recognize that several configurations of cover plate 14 are suitable to provide a cover for the fasteners holding wall portion 16 against wall 92.

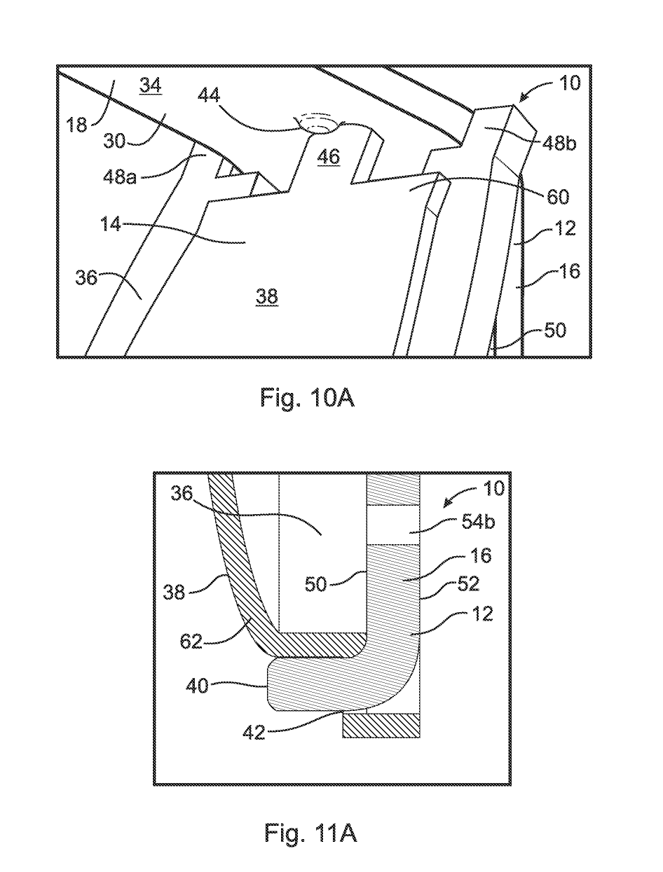

FIG. 9 also demonstrates how cover plate 14 is held in place over wall portion 16. Slot 42 receives protrusion 40 extending from first bracket end 56 to hold and support first plate end 62. Extensions 48a and 48b (not shown in FIG. 9) extend from opposite sides of second plate end 60 up to or above extension portion 18 to prevent cover plate 14 from falling laterally to either side of wall portion 16. In a preferred embodiment, extensions 48a and 48b form shoulders that fit against lower surface 34 to provide a tight fit. (See FIG. 10A.) Tab extension 46 fits between convex projection 44 and the bend between wall portion 16 and extension portion 18 to prevent it from falling away from bracket 10.

FIG. 9A is a cross-sectional view of the present invention, depicting cover plate 14 detached from the bracket 10. With cover plate 14 detached, screw holes 54a and 54b are exposed for installation or repair. Clearly seen is slot 42 at first plate end 62 as well as tab extension 46 at second plate end 60.

FIG. 10A is an enlarged view of the area 10A shown in FIG. 2. FIG. 10A clearly depicts tab extension 46 fitting between convex projection 44 and the point where extension portion 18 extends from wall portion 16 of bracket 10. Preferably, tab extension 46 fits snugly between the extension point and convex projection 44 to create a tight fit of cover plate 14 against front surface 50.

FIG. 11A is a partial cross-sectional view of the area 11A shown in FIG. 9. FIG. 11A depicts protrusion 40 extending from wall portion 16 into slot 42. This view clearly demonstrates how this arrangement holds first plate end 62 in position to prevent cover plate 14 from falling off wall portion 16. Also seen is the space between raised surface 38 and front surface 50 which provides room for a fastener extending from hole 54b. It will be recognized that room is also provided for a fastener extending from hole 54a (not shown in FIG. 11A).

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### PARTS LIST

10 Bracket and cover plate assembly
12 Bracket
14 Cover plate
16 Wall portion (bracket)
18 Extension portion (bracket)
20 Curved portion (extension portion of bracket)
22 Aperture (curved portion)
24 Screw (curved portion)
26 Inner surface (curved portion)
28 Outer surface of curved portion (curved portion)
30 Horizontal portion (extension portion of bracket)
32 Upper surface of horizontal portion (extension portion)
34 Lower surface of horizontal portion (extension portion)
36 Recessed surface of cover plate
36 Raised surface of cover plate
38 Protrusion (wall portion)
40 Slot (recessed surface of cover plate)
42 Convex projection (horizontal portion)
46 Tab extension (cover plate)
48a-b Extensions (recessed surface of cover plate)
50 Front surface (wall portion)
52 Rear surface (wall portion)
54a-b Openings (wall portion of bracket)
56 First end (bracket)
58 Second end (bracket)
60 Second end (cover plate)
62 First end (cover plate)
90 Rod
92 Wall
94 Drape

What is claimed is:

1. A bracket assembly, comprising:
a mounting bracket having a wall portion and an extension portion, said wall portion including a first end and operatively arranged to be mounted to a substantially planar surface, and said extension portion joined with and extending outwardly from said wall portion and including a second end, wherein said extension portion is operatively arranged to hold a drapery rod; and,
a cover plate having a first plate end and a second plate end, said cover plate arranged to matingly engage said wall portion of said mounting bracket.

2. The bracket assembly of claim 1 wherein said extension portion is integral with said wall portion.

3. The bracket assembly of claim 1, wherein said extension portion extends outwardly from said wall portion such that it is substantially perpendicular to said wall portion.

4. The bracket assembly of claim 1, wherein said first plate end has a slot and said second plate end has a tab extension extending upwardly from said second end.

5. The bracket assembly of claim 4, wherein said extension portion comprises an upper surface and a lower surface, said lower surface including a convex projection extending downwardly from said lower surface, such that said tab extension is operatively arranged to be secured between said convex projection and said wall portion.

6. The bracket assembly of claim 4, wherein said first plate end includes a slot and said first end of said wall portion includes a protrusion integral with and extending substantially perpendicular to said wall portion, such that said protrusion is operatively arranged to extend through said slot of said cover plate when said cover plate is secured to said wall portion.

7. The bracket assembly of claim 1, wherein said cover plate is removably secured to said wall portion.

8. The bracket assembly of claim 1, wherein said extension portion includes a curved portion and a substantially horizontal portion.

9. The bracket assembly of claim 8, wherein said curved portion includes an aperture and a screw and is operatively arranged to receive a drapery rod, said drapery rod being held in place by said screw.

10. The bracket assembly of claim 1, wherein said cover plate includes a recessed surface and a raised surface.

11. The bracket assembly of claim 1, wherein said wall portion of said bracket is fastened to said substantially planar surface by at least two screws.

12. The bracket assembly of claim 1, wherein said cover plate is made of plastic.

13. The bracket assembly of claim 1, wherein said mounting bracket is made of metal.
